(19) United States
(12) Patent Application Publication
(10) Pub. No.: US 2013/0268570 A1
(43) Pub. Date: Oct. 10, 2013

(54) REPRESENTATIVE-VALUE CALCULATING DEVICE AND METHOD

(71) Applicant: Heung Seob Koo, Cheongju-si (KR)

(72) Inventor: Heung Seob Koo, Cheongju-si (KR)

(21) Appl. No.: 13/989,478

(22) PCT Filed: Nov. 25, 2011
(86) PCT No.: PCT/KR11/09067

§ 371 Date: Jul. 1, 2013

(30) Foreign Application Priority Data
Nov. 26, 2010 (KR) 10-2010-0119228

(51) Int. Cl. G06F 17/18

(52) U.S. Cl. CPC G06F 17/18
USPC 708/202

(57) ABSTRACT

An apparatus and a method for calculating representative values are provided. The apparatus includes a first calculation unit which calculates a median value and a median absolute deviation (MAD), or a mean value and a standard deviation of process condition values for each sampling point, by using the process condition values which have been measured through a sensor for the each sampling point for each sample; a second calculation unit which calculates standardized values by using the process condition values, the median value, and the median absolute deviation (MAD), or calculates standardized values by using the process condition values, the mean value, and the standard deviation; and a third calculation unit which calculates a representative value of the process condition values for the each sample based on the calculated standardized values.

### BACKGROUND

1. Field

The present invention relates to an apparatus and a method for calculating representative values, in which the representative values are calculated through values which have been measured for a process condition in process systems, and the calculated representative values are displayed in a display unit.

2. Description of the Related Art

In general, enormous investment costs are required in high-tech industries such as a semiconductor industry and an LCD industry. In particular, most of the costs correspond to equipment costs. Accordingly, manufacturing companies in the high-tech industries are essentially making an effort to improve a using rate of the equipment.

Technologies by which malfunctions are detected through monitoring data for process condition such as a temperature, a pressure, and a time are illustrated as one of the methods for improving the using rate of the equipment.

In the process systems, sensors may be installed to measure data for process conditions depending on a time variation. Users can grasp a variation of values for the process conditions depending on the time variation on the basis of the data which has been measured through the sensors. This helps the users apprehend a current state of the equipment.

However, since the values for the process conditions are continuously measured at a time interval of several seconds, and there are more than tens or hundreds of process conditions in the process systems, an amount of data for the process conditions become enormous. Accordingly, a technology, by which a large amount of data for the process conditions is analyzed and displayed through a statistic technique so that the users can conveniently view accurate data, is needed. Such a technology as described above pertains to fields of Fault Detection and Classification (FDC).

Contents related to a technology by which measurement data through sensors for operation processes is displayed in a display unit are disclosed in Korean Patent Publication No. 2001-0079426, the title of which is “A Control Management System of Injection Molding Process”.

Moreover, in order to reduce a large amount of data for the process conditions, instead of a method in which data obtained in times is stored as it is, a method in which process conditions are separated for samples, a representative value capable of representing data obtained in times with one value is calculated, and the calculated representative value is used for storage and analysis is being used. Accordingly, not only storage capacity can be reduced, but also a variation tendency of data can be easily apprehended based on the representative value.

### SUMMARY

In one aspect, there is provided a representative value calculating apparatus capable of calculating representative values of process condition values by using values of the process condition which have been measured in process systems.

In one general aspect, there is provided a representative value calculating apparatus. The representative value calculating apparatus includes: a first calculation unit which calculates a median value and a median absolute deviation (MAD), or a mean value and a standard deviation of process condition values for each sampling point, by using the process condition values which have been measured through a sensor for the each sampling point for each sample; a second calculation unit which calculates standardized values by using the process condition values, the median value, and the median absolute deviation (MAD), or calculates standardized values by using the process condition values, the mean value, and the standard deviation; and a third calculation unit which calculates a representative value of the process condition values for the each sample based on the calculated standardized values.

The representative value calculating apparatus may further include an extraction unit which extracts only the process condition values corresponding to sampling points which have been set by a user among the measured process condition values.

The third calculation unit may calculate a representative value of the process condition values based on any one of a mean value, a median value, a mode, a minimum value, a maximum value, and a standard deviation of the calculated standardized values.

The representative value calculating apparatus may further include a controller which displays at least one of the standardized values for the each sampling point, the calculated representative value for the each sample, and an accumulated sum of the calculated representative value for the each sample in a display unit.

In another general aspect, there is provided a representative value calculating method. The representative value calculating method includes: calculating a median value and a median absolute deviation (MAD), or a mean value and a standard deviation of process condition values for each sampling point, by using the process condition values which have been measured through a sensor for the each sampling point for each sample; calculating standardized values by using the process condition values, the median value, and the median absolute deviation (MAD), or calculating standardized values by using the process condition values, the mean value, and the standard deviation; and calculating a representative value of the process condition values for the each sample based on the calculated standardized values.

The representative value calculating method may further include extracting only the process condition values corresponding to sampling points which have been set by a user among the measured process condition values.

The calculating the representative value may include calculating the representative value of the process condition values based on any one of a mean value, a median value, a mode, a minimum value, a maximum value, and a standard deviation of the calculated standardized values.

The representative value calculating method may further include displaying at least one of the standardized values for the each sampling point, the calculated representative value for the each sample, and an accumulated sum of the calculated representative value for the each sample in a display unit.

According to embodiments of the present invention, through a standardization process, since the values for the process condition between which there are large magnitude differences are changed to the standardized values between which there are small magnitude differences, the magnitude differences between the standardized values can be reduced. In addition, since the representative values of the values for the process condition are calculated through the standardized values with the reduced magnitude differences, correctness of the representative values can be enhanced. Moreover, since the magnitude differences between the standardized values are reduced so that the correctness of the representative values is enhanced, it is not necessary to intentionally remove the values corresponding to the portion of deteriorating the correctness of the representative values (‘the portion of generating a transient phenomenon’) among the values for the measured process condition.

Furthermore, since the magnitude differences between the standardized values are reduced through the standardization process, several variables with considerably different scales can be displayed all together on one chart, whereby the values corresponding to the variables can be easily compared.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a block diagram showing a representative value calculating apparatus according to an embodiment of the present invention.

FIG. 2 is a graph depicting standardized values versus sampling points for some samples.

FIGS. 3A and 3B are graphs depicting measured process condition values and standardized values for sampling points.

FIG. 4 is a graph depicting calculated representative values versus sampling points.

FIG. 5 is a graph depicting accumulated sum values versus sampling points.

FIG. 6 is a flowchart showing a method, through which a representative value calculating apparatus calculates representative values, according to an embodiment of the present invention.

FIG. 7 is a flowchart showing a method, through which a representative value calculating apparatus calculates representative values, according to another embodiment of the present invention.

Elements, features, and structures are denoted by the same reference numerals throughout the drawings and the detailed description, and the size and proportions of some elements may be exaggerated in the drawings for clarity and convenience.

### DETAILED DESCRIPTION

Hereinafter, detailed description for carrying out the present invention will be given with reference to the accompanying drawings.

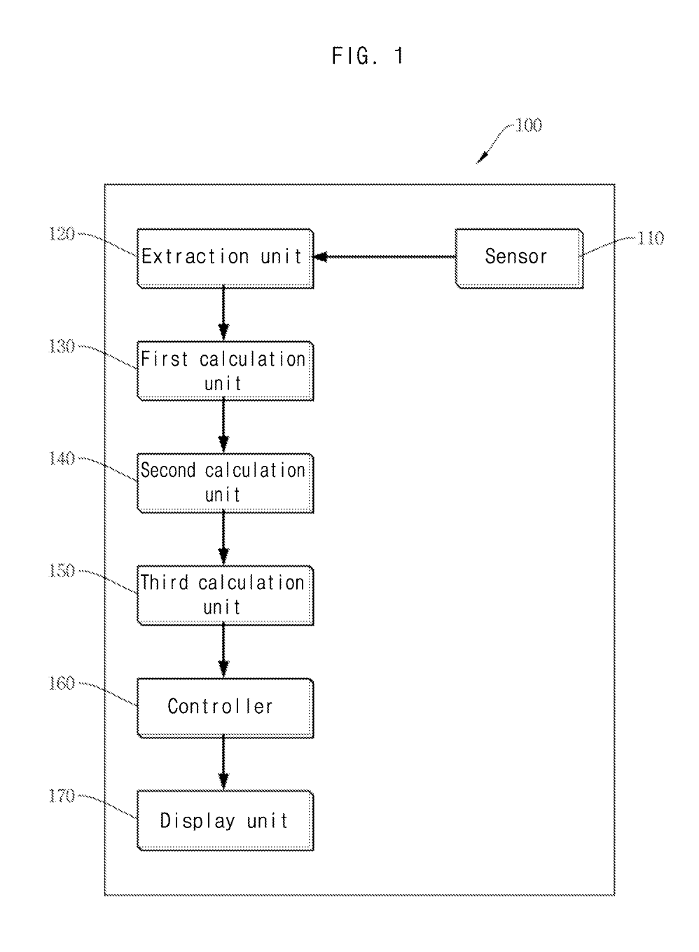

FIG. 1 is a block diagram showing a representative value calculating apparatus according to an embodiment of the present invention.

Referring to FIG. 1, the representative value calculating apparatus 100 includes a sensor 110, an extraction unit 120, a first calculation unit 130, a second calculation unit 140, a third calculation unit 150, a controller 160, and a display unit 170.

The representative value calculating apparatus 100 may be installed in a process apparatus or a process system.

The sensor 110 may be installed in the process apparatus or the process system, and may measure values for a process condition for each sample according to a preset measuring period. The process condition includes various conditions, which are necessary for processes, such as a temperature, a pressure, a time and a location of a product.

A plurality of sampling points may exist in one step. The sampling points imply locations at which the sensor 110 has measured the process condition. For example, when it takes a time of 26 seconds to perform one step and a measuring period is 2 seconds, the sensor 110 measures the values for the process condition every 2 seconds so that a total of 13 sampling points are generated until the one step is completed.

The predetermined measuring period may be set by users or manufacturers.

The samples may correspond to respective products. For example, in a case of a process for producing 40 semiconductor wafers, the samples may correspond to the semiconductor wafers, respectively.

A recipe includes information such as an operating method and a facility manipulating method for producing the products. The operating method and the facility manipulating method include several steps, and process conditions required for each step are different from each other. The process conditions imply various conditions, which are necessary for the processes, such as a temperature, a pressure, a time and a location of a product. For example, in ‘A’ step, a process condition where a process should be performed at a temperature of 100 degrees Celsius for one minute may be required, and in ‘B’ step, a process condition where a process should be performed at a temperature of 50 degrees Celsius and a pressure of 1 atmosphere for twenty seconds may be required. Giving an example of the sensor 110, in-situ sensors may be installed in a semiconductor device apparatus, and may measure various pieces of information such that a process progress state in an interior of a chamber may be monitored in real time.

The information acquired through the sensor 110 may be expressed as shown in Table 1 and Table 2. Table 1 and Table 2 show values which the sensor 110 has measured for process condition 1 (for example, a temperature). First row corresponds to sampling points, and first column corresponds to the number of samples. In Table 1 and Table 2, a total number of the sampling points are eleven, and a total number of the samples are forty. However, the number of the sampling points and the samples corresponds to mere one embodiment, and may be variously varied.

TABLE 1

| | 1 | 2 | 3 | 4 | 5 | 6 |
|---|---|---|---|---|---|---|
| #1 | 3.08278 | 4.7734 | 3.3364 | 3.0865 | 5.0858 | 7.9599 |
| #2 | 10.3342 | 3.6488 | 3.0865 | 3.3989 | 6.3354 | 8.8347 |
| #3 | 6.8353 | 3.2739 | 2.9615 | 4.6485 | 7.0852 | 9.397 |
| #4 | 11.3964 | 3.5863 | 3.0865 | 3.3989 | 6.023 | 8.4598 |
| #5 | 22.8303 | 4.2111 | 3.0865 | 2.9615 | 5.8981 | 8.0849 |
| #6 | 6.273 | 3.2739 | 3.024 | 4.6485 | 7.0227 | 9.6469 |
| #7 | 9.5844 | 3.3989 | 2.9615 | 3.5863 | 6.5854 | 8.8971 |
| #8 | 8.3348 | 3.5238 | 2.9615 | 3.7737 | 6.3354 | 9.3345 |
| #9 | 6.6478 | 3.2739 | 3.0865 | 4.6485 | 7.0227 | 9.5844 |
| #10 | 12.8334 | 3.6488 | 3.024 | 3.2739 | 6.0855 | 8.6472 |
| #11 | 12.5835 | 3.9612 | 3.024 | 3.2739 | 5.9606 | 8.4598 |
| #12 | 9.8343 | 3.3989 | 3.0865 | 3.5238 | 6.7103 | 9.0221 |
| #13 | 3.50077 | 5.3358 | 3.3364 | 2.9615 | 5.0233 | 7.8975 |
| #14 | 7.1852 | 3.4989 | 3.4989 | 5.4982 | 8.8722 | 12.1212 |
| #15 | 7.4351 | 3.5613 | 3.6863 | 4.8734 | 8.8722 | 12.0587 |
| #16 | 6.7478 | 3.8737 | 3.7488 | 5.4982 | 8.4973 | 12.1212 |
| #17 | 9.8094 | 3.4989 | 3.3739 | 4.3736 | 7.8725 | 11.1215 |
| #18 | 11.4339 | 3.9987 | 3.124 | 4.3736 | 7.3726 | 10.934 |
| #19 | 5.4358 | 3.5613 | 3.4989 | 6.1855 | 9.497 | 12.746 |
| #20 | 7.4976 | 3.8113 | 3.4989 | 4.9359 | 8.4973 | 11.1215 |
| #21 | 4.561 | 2.1868 | 0.8747 | 1.0621 | 1.437 | 1.4995 |
| #22 | 7.5601 | 2.4367 | 1.437 | 1.1871 | 1.4995 | 1.437 |
| #23 | 8.0599 | 2.999 | 1.4995 | 1.0621 | 1.1871 | 1.1871 |
| #24 | 9.1846 | 2.999 | 1.562 | 0.9996 | 1.1871 | 1.4995 |
| #25 | 6.7478 | 2.5616 | 1.4995 | 1.1871 | 1.3745 | 1.4995 |
| #26 | 4.3736 | 2.2492 | 0.8747 | 1.4995 | 1.1871 | 1.1871 |
| #27 | 4.1237 | 1.562 | 0.9372 | 1.1871 | 1.4995 | 1.4995 |
| #28 | 6.1855 | 2.3742 | 1.2496 | 1.1871 | 1.1871 | 1.437 |
| #29 | 6.0606 | 2.4992 | 1.1246 | 1.312 | 1.1246 | 1.437 |
| #30 | 6.373 | 2.3117 | 1.1871 | 1.4995 | 1.4995 | 1.4995 |
| #31 | 3.7488 | 1.9368 | 1.1871 | 1.1246 | 1.3745 | 1.4995 |
| #32 | 4.3111 | 1.6869 | 1.1246 | 1.1871 | 1.437 | 1.437 |
| #33 | 4.2486 | 1.9368 | 1.1871 | 1.3745 | 1.437 | 1.562 |
| #34 | 6.7478 | 2.4367 | 1.1246 | 1.0621 | 1.4995 | 1.312 |
| #35 | 7.935 | 2.999 | 1.4995 | 1.0621 | 1.4995 | 1.4995 |
| #36 | 3.4333 | 3.6238 | 1.4995 | 1.1871 | 1.1871 | 1.4995 |
| #37 | 7.3726 | 2.4367 | 1.6244 | 0.9996 | 1.1871 | 1.1246 |
| #38 | 7.1852 | 2.4367 | 1.562 | 1.1871 | 1.4995 | 1.4995 |
| #39 | 4.3736 | 1.8744 | 1.1871 | 1.1871 | 1.1871 | 1.437 |
| #40 | 5.4358 | 2.3742 | 1.1871 | 1.1246 | 1.4995 | 1.6244 |

TABLE 2

| 7 | 8 | 9 | 10 | 11 |
|---|---|---|---|---|
| 10.3342 | 3.024 | 0.6497 | 0.5872 | 0.3998 |
| 8.0849 | 0.5872 | 0.6497 | 0.4623 | 0.6497 |
| 11.0215 | 0.8996 | 0.5872 | 0.5872 | |
| 10.7716 | 1.462 | 0.5872 | 0.5872 | 0.7122 |
| 9.4595 | 0.6497 | 0.5872 | 0.5872 | 0.5872 |
| 11.3964 | 0.6497 | 0.6497 | 0.4623 | 0.5872 |
| 11.8962 | 0.6497 | 0.6497 | 0.3373 | 0.6497 |
| 9.7719 | 0.5872 | 0.5872 | 0.6497 | 0.5248 |
| 11.084 | 1.0871 | 0.5872 | 0.3998 | |
| 11.2714 | 1.3995 | 0.5872 | 0.6497 | 0.6497 |
| 11.5213 | 0.7747 | 0.4623 | 0.7122 | 0.6497 |
| 10.3967 | 0.40237 | 0.7122 | 0.5872 | 0.5872 |
| 7.4351 | 0.8122 | 0.9372 | 0.8122 | |
| 14.1205 | 0.9996 | | | |
| 11.3714 | 0.7497 | 0.9996 | 0.7497 | 0.9372 |
| 14.3705 | 0.9996 | 0.8747 | 0.9372 | 0.6872 |
| 14.0581 | 1.1246 | 0.6872 | 0.9996 | |
| 4.686 | 0.9372 | 0.6872 | 0.9372 | 0.6872 |
| 13.9956 | 0.8122 | 0.8122 | 0.7497 | 0.9372 |
| 0.3748 | 0.0624 | 0.1874 | 0.0624 | 0.2499 |
| 0.9372 | 0 | 0 | 0.1249 | |
| 1.562 | 0 | 0 | | |
| 1.437 | 0.1249 | 0.1874 | 0.0624 | 0.0624 |
| 1.2496 | 0.1249 | 0.0624 | 0 | 0 |
| 0.1874 | 0.0624 | 0.0624 | 0 | 0.1249 |
| 0 | 0.1874 | 0.1874 | 0.1249 | 0.2499 |
| 0.8747 | 0.0624 | 0.0624 | 0.1874 | 0.2499 |
| 0.8747 | 0.1249 | 0.0624 | 0.1249 | 0.1874 |
| 1.0621 | 0.1249 | 0 | 0.0624 | 0.1874 |
| 0.1874 | 0 | 0 | 0 | 0.1249 |
| 0.1874 | 0.1874 | 0 | 0.0624 | 0.0624 |
| 0.2499 | 0.0624 | 0.0624 | 0.1249 | 0.0624 |
| 1.4995 | 0 | 0.1249 | 0 | 0.1874 |
| 1.4995 | 0.4998 | 0.1249 | 0 | 0.2499 |
| 1.4995 | 0.1249 | 0.1249 | 0.3748 | 0.0624 |
| 1.562 | 0.2499 | 0.3124 | 0.1249 | 0.0624 |
| 1.3745 | 0.1874 | 0.1249 | 0 | 0 |
| 0.3748 | 0 | 0 | 0.1874 | 0.1249 |
| 0.6872 | 0.1874 | 0 | 0 | 0.1249 |

The information acquired through the sensor 110 may be expressed as shown in Table 3 and Table 4. Table 3 and Table 4 show values which the sensor 110 has measured for process condition 2 (for example, a pressure). First row corresponds to sampling points, and first column corresponds to the number of samples. In Table 3 and Table 4, a total number of the sampling points is eleven, and a total number of the samples is forty. However, the number of the sampling points and the samples corresponds to mere one embodiment, and may be variously varied.

TABLE 3

| sample # | 1 | 2 | 3 | 4 | 5 | 6 |
|---|---|---|---|---|---|---|
| #1 | 330.4628331 | 100.160885 | 30.51358818 | 9.217116614 | 10.50585539 | 11.13922152 |
| #2 | 380.3805479 | 130.9025424 | 40.57750649 | 11.64172347 | 9.86411062 | 10.83165185 |
| #3 | 380.6711252 | 150.2400937 | 40.50504315 | 8.195122056 | 9.589144058 | 10.61850909 |
| #4 | 290.3585188 | 180.2847009 | 50.95184537 | 10.54503009 | 11.09992197 | 9.973616597 |
| #5 | 361.1753884 | 120.1006175 | 40.38202722 | 8.057241696 | 9.179803066 | 10.16535673 |
| #6 | 340.3453545 | 100.4984354 | 30.68580461 | 10.23413853 | 8.612669057 | 9.356521876 |
| #7 | 300.8805121 | 150.7433733 | 50.3624409 | 10.96957042 | 10.01249957 | 10.04030151 |
| #8 | 250.9415543 | 60.64695349 | 20.16570977 | 8.902652926 | 10.4982885 | 8.431349859 |
| #9 | 250.105224 | 60.06057366 | 20.70347717 | 10.27212017 | 10.82741684 | 10.04293006 |
| #10 | 380.1773277 | 270.3236907 | 80.46615542 | 10.42269166 | 8.523593459 | 9.060005322 |
| #11 | 400.7508207 | 370.1826229 | 130.268707 | 15.01487195 | 12.57884162 | 11.4477515 |
| #12 | 350.7886084 | 270.5880844 | 160.1901412 | 11.25323071 | 12.84238284 | 10.18232675 |
| #13 | 370.1231865 | 130.4211294 | 30.39733325 | 12.01315406 | 10.35747906 | 9.74433827 |
| #14 | 230.1449774 | 70.61897298 | 20.79222153 | 10.73735678 | 10.31916567 | 10.05682801 |
| #15 | 290.5958573 | 150.1140805 | 50.87474827 | 8.335267633 | 11.0782124 | 11.89622919 |
| #16 | 280.7515674 | 280.8480338 | 70.03325901 | 11.88889338 | 10.41122875 | 10.0636595 |
| #17 | 330.3037076 | 250.8835243 | 60.75070484 | 12.97378468 | 9.813538586 | 9.756297955 |
| #18 | 360.1628536 | 230.4689901 | 60.72703978 | 12.0477055 | 10.71487999 | 10.01563013 |
| #19 | 330.9746554 | 180.8046801 | 170.1326335 | 10.43609829 | 8.595277952 | 9.840890332 |
| #20 | 320.1368842 | 310.3697104 | 100.3819528 | 9.544157481 | 10.13342153 | 8.196713379 |
| #21 | 300.7546607 | 150.0667491 | 40.02625552 | 10.97920934 | 12.85345361 | 11.99253051 |
| #22 | 230.4089898 | 170.152245 | 50.02697698 | 10.04264491 | 13.75397936 | 11.65691301 |
| #23 | 300.7607774 | 100.9447663 | 30.99213252 | 10.9015152 | 10.22591286 | 10.88616379 |
| #24 | 370.8957567 | 290.2954571 | 90.14989147 | 12.62050082 | 12.15308107 | 9.933096605 |
| #25 | 370.6306886 | 130.0887302 | 40.01801012 | 10.43741031 | 10.10530761 | 10.08440016 |
| #26 | 360.3191875 | 210.3718672 | 50.87518181 | 9.573328974 | 13.70200204 | 11.0060575 |
| #27 | 370.938481 | 150.7187381 | 40.24524055 | 10.39191874 | 8.057649994 | 9.932068661 |
| #28 | 290.8273522 | 210.7975375 | 50.25044152 | 10.68496478 | 10.61281678 | 10.53287868 |
| #29 | 270.6909429 | 80.88743301 | 20.75294533 | 10.01716135 | 10.17165318 | 10.99785769 |
| #30 | 310.3842332 | 210.2170016 | 50.80063188 | 11.48392112 | 12.84953392 | 8.950375543 |
| #31 | 300.2222245 | 230.0132381 | 60.75244903 | 23.60518696 | 10.62818388 | 11.15033264 |
| #32 | 340.5597385 | 100.1820943 | 30.30821411 | 13.7917826 | 11.39726916 | 9.094713974 |
| #33 | 370.8534497 | 110.3134754 | 30.19774994 | 10.92831549 | 10.43699389 | 9.288588297 |
| #34 | 340.6289641 | 100.7220668 | 30.17162313 | 12.94053154 | 10.04793088 | 8.110155443 |
| #35 | 280.4092177 | 70.09756622 | 20.51215622 | 9.541625174 | 10.51800533 | 10.28197808 |
| #36 | 290.4992302 | 180.4813449 | 50.28849099 | 12.43825243 | 10.3775814 | 10.78629124 |
| #37 | 380.3503839 | 300.9097993 | 80.178668 | 11.7642773 | 9.94446115 | 9.24057969 |
| #38 | 340.7743314 | 110.164399 | 30.7757818 | 12.42119585 | 10.85461866 | 8.745305294 |
| #39 | 330.3911756 | 170.272292 | 50.95276051 | 10.52405472 | 9.980991012 | 9.93531918 |
| #40 | 400.8593387 | 380.9031308 | 40.9760403 | 11.23783369 | 10.8307735 | 10.20564295 |

TABLE 4

| 7 | 8 | 9 | 10 | 11 |
|---|---|---|---|---|
| 9.119430597 | 8.446991967 | 9.663602043 | 10.79711356 | 11.15819018 |
| 11.24787773 | 10.25710585 | 10.55748353 | 9.355803498 | 11.31199923 |
| 8.472432776 | 9.84423797 | 10.44289104 | 10.90054287 | |
| 10.80398677 | 11.28129444 | 10.09969147 | 9.459717785 | 10.00236721 |
| 11.74036709 | 10.89140913 | 10.48372672 | 9.13708099 | 9.720183867 |
| 10.08785551 | 10.48252485 | 10.55373905 | 10.17995544 | 10.63944289 |
| 9.969373793 | 10.78767519 | 10.10330683 | 11.6345476 | 10.99831211 |
| 10.70907561 | 10.89608978 | 10.73797829 | 10.80618335 | 10.55611392 |
| 9.229492789 | 9.339580304 | 9.896153982 | 10.0215543 | |
| 11.34561006 | 9.254570236 | 9.219533983 | 9.601568904 | 9.654250101 |
| 9.340390082 | 9.375534982 | 8.280130761 | 10.70482322 | 11.82980282 |
| 9.597549436 | 9.428101642 | 8.245923712 | 10.03431775 | |
| 10.29374254 | 10.12555569 | | | |
| 10.15494195 | 10.87271598 | 9.64419727 | 9.006764369 | 8.476712701 |
| 9.953553847 | 9.429868876 | 9.615641843 | 9.956155617 | 10.94356428 |
| 9.566392931 | 10.64263874 | 10.90015592 | 10.2366041 | 10.15385656 |
| 10.5572553 | 10.80117564 | 10.0231738 | 10.3017831 | |
| 9.812812296 | 12.84824371 | 12.34768729 | 10.29438309 | 11.33581947 |
| 8.11821458 | 8.496783106 | 9.785590618 | 9.898643139 | 10.73410929 |
| 11.05852573 | 9.089995642 | 9.098755592 | 10.51358186 | 10.90034643 |
| 10.46659664 | 10.92773193 | 9.945699664 | 9.805797207 | |
| 10.31816259 | 10.52164819 | 10.99972613 | | |
| 8.167266243 | 8.647587409 | 9.514655968 | 9.002780097 | 10.20403131 |
| 10.96322911 | 10.9971237 | 10.50206555 | 10.60007033 | 10.55507471 |
| 9.6462473 | 9.367114848 | 8.241437307 | 9.008454344 | 11.03327534 |
| 9.246789608 | 9.916203591 | 11.41988646 | 11.08239574 | 12.48109877 |
| 10.47320248 | 10.02161306 | 10.70520418 | 10.63145239 | 10.09066491 |
| 8.733202987 | 10.57769289 | 10.4716797 | 9.257637751 | 10.13868713 |
| 8.691959989 | 8.618926854 | 8.328623114 | 9.849721749 | 9.26215644 |
| 12.1539496 | 8.444348093 | 9.977928217 | 9.745521495 | 9.430254984 |
| 8.091424843 | 8.895517778 | 9.107696181 | 10.56306856 | 11.34480722 |
| 9.918957057 | 8.15708254 | 8.81976843 | 10.74815278 | 11.69682688 |
| 8.278881868 | 8.075457444 | 9.729748919 | 9.528817679 | 9.612088127 |
| 10.67274928 | 10.5950984 | 10.7323474 | 11.81595775 | 10.01044747 |
| 8.56894155 | 9.628587477 | 8.574729382 | 9.664938744 | 10.19880395 |
| 9.862644257 | 8.317141973 | 11.92985499 | 11.93215747 | 10.31847275 |
| 8.757716524 | 9.986004113 | 9.266039576 | 9.521337411 | 9.566979942 |
| 9.723014356 | 9.455199235 | 9.128015871 | 9.787385876 | 9.776761639 |
| 10.31259488 | 8.008257944 | 8.669055792 | 10.07987555 | 10.22460733 |

The extraction unit 120 may extract only the process condition values corresponding to the user set sampling points among the measured process condition values. For example, the sampling points may be variously set in the same way as second to tenth sampling points, sampling points with a sampling point number fewer than or equal to an average number of the sampling points, and sampling points with a sampling point number fewer than or equal to 90% of a total number of the sampling points are excluded.

The extraction unit 120 may set the process condition values of cells in which there is no process condition value as a null.

For example, the extraction unit 120 may extract only the process condition values corresponding to the sampling points which the user has set in Table 1 and Table 2. For example, the extracted results may correspond to those shown in Table 5 and Table 6.

TABLE 5

| sample # | 1 | 2 | 3 | 4 | 5 | 6 |
|---|---|---|---|---|---|---|
| #3 | 6.8353 | 3.2739 | 2.9615 | 4.6485 | 7.0852 | 9.397 |
| #4 | 11.3964 | 3.5863 | 3.0865 | 3.3989 | 6.023 | 8.4598 |
| #5 | 22.8303 | 4.2111 | 3.0865 | 2.9615 | 5.8981 | 8.0849 |
| #6 | 6.273 | 3.2739 | 3.024 | 4.6485 | 7.0227 | 9.6469 |
| #7 | 9.5844 | 3.3989 | 2.9615 | 3.5863 | 6.5854 | 8.8971 |
| #8 | 8.3348 | 3.5238 | 2.9615 | 3.7737 | 6.3354 | 9.3345 |
| #9 | 6.6478 | 3.2739 | 3.0865 | 4.6485 | 7.0227 | 9.5844 |
| #10 | 12.8334 | 3.6488 | 3.024 | 3.2739 | 6.0855 | 8.6472 |
| #21 | 4.561 | 2.1868 | 0.8747 | 1.0621 | 1.437 | 1.4995 |
| #22 | 7.5601 | 2.4367 | 1.437 | 1.1871 | 1.4995 | 1.437 |
| #23 | 8.0599 | 2.999 | 1.4995 | 1.0621 | 1.1871 | 1.1871 |
| #24 | 9.1846 | 2.999 | 1.562 | 0.9996 | 1.1871 | 1.4995 |
| #25 | 6.7478 | 2.5616 | 1.4995 | 1.1871 | 1.3745 | 1.4995 |
| #26 | 4.3736 | 2.2492 | 0.8747 | 1.4995 | 1.1871 | 1.1871 |
| #27 | 4.1237 | 1.562 | 0.9372 | 1.1871 | 1.4995 | 1.4995 |
| #28 | 6.1855 | 2.3742 | 1.2496 | 1.1871 | 1.1871 | 1.437 |

TABLE 6

| 7 | 8 | 9 | 10 | 11 |
|---|---|---|---|---|
| 8.0849 | 0.5872 | 0.6497 | 0.4623 | 0.6497 |
| 11.0215 | 0.8996 | 0.5872 | 0.5872 | 0 |
| 10.7716 | 1.462 | 0.5872 | 0.5872 | 0.7122 |
| 9.4595 | 0.6497 | 0.5872 | 0.5872 | 0.5872 |
| 11.3964 | 0.6497 | 0.6497 | 0.4623 | 0.5872 |
| 11.8962 | 0.6497 | 0.6497 | 0.3373 | 0.6497 |
| 9.7719 | 0.5872 | 0.5872 | 0.6497 | 0.5248 |
| 11.084 | 1.0871 | 0.5872 | 0.3998 | 0 |
| 0.3748 | 0.0624 | 0.1874 | 0.0624 | 0.2499 |
| 0.9372 | 0.00000 | 0.00000 | 0.1249 | 0 |
| 1.562 | 0.00000 | 0.00000 | 0 | 0 |
| 1.437 | 0.1249 | 0.1874 | 0.0624 | 0.0624 |
| 1.2496 | 0.1249 | 0.0624 | 0.00000 | 0 |
| 0.1874 | 0.0624 | 0.0624 | 0.00000 | 0.1249 |
| 0.00000 | 0.1874 | 0.1874 | 0.1249 | 0.2499 |
| 0.8747 | 0.0624 | 0.0624 | 0.1874 | 0.2499 |

The extraction unit 120 may extract only the process condition values corresponding to the sampling points which the user has set in Table 3 and Table 4. For example, the extracted results may correspond to those shown in Table 7 and Table 8.

TABLE 7

| sample # | 1 | 2 | 3 | 4 | 5 | 6 |
|---|---|---|---|---|---|---|
| #3 | 380.6711252 | 150.2400937 | 40.50504315 | 8.195122056 | 9.589144058 | 10.61850909 |
| #4 | 290.3585188 | 180.2847009 | 50.95184537 | 10.54503009 | 11.09992197 | 9.973616597 |
| #5 | 361.1753884 | 120.1006175 | 40.38202722 | 8.057241696 | 9.179803066 | 10.16535673 |
| #6 | 340.3453545 | 100.4984354 | 30.68580461 | 10.23413853 | 8.612669057 | 9.356521876 |
| #7 | 300.8805121 | 150.7433733 | 50.3624409 | 10.96957042 | 10.01249957 | 10.04030151 |
| #8 | 250.9415543 | 60.64695349 | 20.16570977 | 8.902652926 | 10.4982885 | 8.431349859 |
| #9 | 250.105224 | 60.06057366 | 20.70347717 | 10.27212017 | 10.82741684 | 10.04293006 |
| #10 | 380.1773277 | 270.3236907 | 80.46615542 | 10.42269166 | 8.523593459 | 9.060005322 |
| #21 | 300.7546607 | 150.0667491 | 40.02625552 | 10.97920934 | 12.85345361 | 11.99253051 |
| #22 | 230.4089898 | 170.152245 | 50.02697698 | 10.04264491 | 13.75397936 | 11.65691301 |
| #23 | 300.7607774 | 100.9447663 | 30.99213252 | 10.9015152 | 10.22591286 | 10.88616379 |
| #24 | 370.8957567 | 290.2954571 | 90.14989147 | 12.62050082 | 12.15308107 | 9.933096605 |
| #25 | 370.6306886 | 130.0887302 | 40.01801012 | 10.43741031 | 10.10530761 | 10.08440016 |
| #26 | 360.3191875 | 210.3718672 | 50.87518181 | 9.573328974 | 13.70200204 | 11.0060575 |
| #27 | 370.938481 | 150.7187381 | 40.24524055 | 10.39191874 | 8.057649994 | 9.932068661 |
| #28 | 290.8273522 | 210.7975375 | 50.25044152 | 10.68496478 | 10.61281678 | 10.53287868 |

TABLE 8

| sample # | 7 | 8 | 9 | 10 | 11 |
|---|---|---|---|---|---|
| #3 | 11.24787773 | 10.25710585 | 10.55748353 | 9.355803498 | 11.31199923 |
| #4 | 8.472432776 | 9.84423797 | 10.44289104 | 10.90054287 | 0 |
| #5 | 10.80398677 | 11.28129444 | 10.09969147 | 9.459717785 | 10.00236721 |
| #6 | 11.74036709 | 10.89140913 | 10.48372672 | 9.13708099 | 9.720183867 |
| #7 | 10.08785551 | 10.48252485 | 10.55373905 | 10.17995544 | 10.63944289 |
| #8 | 9.969373793 | 10.78767519 | 10.10330683 | 11.6345476 | 10.99831211 |
| #9 | 10.70907561 | 10.89608978 | 10.73797829 | 10.80618335 | 10.55611392 |
| #10 | 9.229492789 | 9.339580304 | 9.896153982 | 10.0215543 | 0 |
| #21 | 11.05852573 | 9.089995642 | 9.098755592 | 10.51358186 | 10.90034643 |
| #22 | 10.46659664 | 10.92773193 | 9.945699664 | 9.805797207 | 0 |
| #23 | 10.31816259 | 10.52164819 | 10.99972613 | 0 | 0 |
| #24 | 8.167266243 | 8.647587409 | 9.514655968 | 9.002780097 | 10.20403131 |
| #25 | 10.96322911 | 10.9971237 | 10.50206555 | 10.60007033 | 10.55507471 |
| #26 | 9.6462473 | 9.367114848 | 8.241437307 | 9.008454344 | 11.03327534 |
| #27 | 9.246789608 | 9.916203591 | 11.41988646 | 11.08239574 | 12.48109877 |
| #28 | 10.47320248 | 10.02161306 | 10.70520418 | 10.63145239 | 10.09066491 |

The first calculation unit 130 may calculate a median value and a median absolute deviation (MAD) of the process condition values for each sampling point, by using the process condition values which have been measured for sampling points for each sample through the sensor 110. The median value, which is a middle value, represents the middle number in a set of numbers, and when the number of the numbers in the set of numbers is an even number, corresponds to a mean value of two numbers in the center of the set.

The first calculation unit 130 may calculate a mean value and a standard deviation of the process condition values for each sampling point, by using the process condition values which have been measured for sampling points for each sample through the sensor 110.

The first calculation unit 130 may calculate a median absolute deviation (MAD) value by using Equation 1.

MAD=a*Median(|Xᵢ−Median(Xⱼ)|) Equation 1

here, a is a correction factor making the MAD identical with a standard deviation for a normal distribution, Xᵢ is a process condition value, Xⱼ is a median value, and Median(X) is a function calculating a median value among X variables.

The first calculation unit 130 assumes that the value of a is 1.4826, and may calculate a median value and a median absolute deviation (MAD) for each sampling point by using Table 5, Table 6, and Equation 1. The calculated results may correspond to those shown in Table 9 and Table 10.

TABLE 9

| Classification | 1 | 2 | 3 | 4 | 5 |
|---|---|---|---|---|---|
| Median | 7.1977 | 3.1365 | 2.2618 | 2.2305 | 3.6988 |
| MAD | 2.3158 | 0.7133 | 1.1764 | 1.7323 | 3.7238 |

TABLE 10

| 6 | 7 | 8 | 9 | 10 | 11 |
|---|---|---|---|---|---|
| 4.7922 | 4.8235 | 0.3873 | 0.3873 | 0.2624 | 0.2499 |
| 5.3449 | 6.8734 | 0.4354 | 0.3427 | 0.2964 | 0.3705 |

The first calculation unit 130 assumes that the value of a is 1.4826, and may calculate a median value and a median absolute deviation (MAD) for each sampling point by using Table 7, Table 8, and Equation 1. The calculated results may correspond to those shown in Table 11 and Table 12.

TABLE 11

| Classification | 1 | 2 | 3 | 4 | 5 |
|---|---|---|---|---|---|
| Median | 320.61293 | 150.4794159 | 40.44353518 | 10.4073052 | 10.36210068 |
| MAD | 67.1471 | 59.2398 | 14.5033 | 0.6367 | 1.4494 |

TABLE 12

| 6 | 7 | 8 | 9 | 10 | 11 |
|---|---|---|---|---|---|
| 10.06366511 | 10.39237962 | 10.36981535 | 10.46330888 | 10.10075487 | 10.37955301 |
| 0.7591 | 0.9170 | 0.7797 | 0.5364 | 1.0752 | 0.9433 |

Although only the results of the median values and the median absolute deviations (MADs), which the first calculation unit 130 has calculated, are described above, the first calculation unit 130 may also calculate mean values and standard deviations.

The second calculation unit 140 may calculate standardized values by using the process condition values, the median value, and the median absolute deviation (MADs).

For example, the second calculation unit 140 may calculate a standardized value by using Equation 2.

Standardized value=(Xᵢ−Xⱼ)/Median Absolute Deviation(MAD) Equation 2

here, Xᵢ is a process condition value, and Xⱼ is a median value.

The second calculation unit 140 may calculate standardized values for process condition 1 by using Table 1, Table 2, the median value and the median absolute deviation (MADs). The calculated results may correspond to those shown in Table 13 and Table 14.

TABLE 13

| sample # | 1 | 2 | 3 | 4 | 5 |
|---|---|---|---|---|---|
| #1 | −1.7769 | 2.2950 | 0.9135 | 0.4941 | 0.3725 |
| #2 | 1.3544 | 0.7183 | 0.7011 | 0.6745 | 0.7080 |
| #3 | −0.1565 | 0.1927 | 0.5948 | 1.3959 | 0.9094 |
| #4 | 1.8131 | 0.6307 | 0.7011 | 0.6745 | 0.6241 |
| #5 | 6.7503 | 1.5066 | 0.7011 | 0.4220 | 0.5906 |
| #6 | −0.3993 | 0.1927 | 0.6479 | 1.3959 | 0.8926 |
| #7 | 1.0306 | 0.3679 | 0.5948 | 0.7827 | 0.7752 |
| #8 | 0.4910 | 0.5431 | 0.5948 | 0.8909 | 0.7080 |
| #9 | −0.2375 | 0.1927 | 0.7011 | 1.3959 | 0.8926 |
| #10 | 2.4336 | 0.7183 | 0.6479 | 0.6023 | 0.6409 |
| #11 | 2.3257 | 1.1563 | 0.6479 | 0.6023 | 0.6074 |
| #12 | 1.1385 | 0.3679 | 0.7011 | 0.7466 | 0.8087 |
| #13 | −1.5964 | 3.0834 | 0.9135 | 0.4220 | 0.3557 |
| #14 | −0.0054 | 0.5081 | 1.0516 | 1.8864 | 1.3893 |
| #15 | 0.1025 | 0.5956 | 1.2109 | 1.5257 | 1.3893 |
| #16 | −0.1943 | 1.0336 | 1.2640 | 1.8864 | 1.2886 |
| #17 | 1.1278 | 0.5081 | 0.9453 | 1.2372 | 1.1208 |
| #18 | 1.8292 | 1.2089 | 0.7329 | 1.2372 | 0.9866 |
| #19 | −0.7608 | 0.5956 | 1.0516 | 2.2831 | 1.5570 |
| #20 | 0.1295 | 0.9461 | 1.0516 | 1.5618 | 1.2886 |
| #21 | −1.1386 | −1.3314 | −1.1790 | −0.6745 | −0.6074 |
| #22 | 0.1565 | −0.9810 | −0.7011 | −0.6023 | −0.5906 |
| #23 | 0.3723 | −0.1927 | −0.6479 | −0.6745 | −0.6745 |
| #24 | 0.8580 | −0.1927 | −0.5948 | −0.7106 | −0.6745 |
| #25 | −0.1943 | −0.8059 | −0.6479 | −0.6023 | −0.6242 |
| #26 | −1.2195 | −1.2439 | −1.1790 | −0.4220 | −0.6745 |
| #27 | −1.3274 | −2.2073 | −1.1259 | −0.6023 | −0.5906 |
| #28 | −0.4371 | −1.0687 | −0.8603 | −0.6023 | −0.6745 |
| #29 | −0.4910 | −0.8934 | −0.9666 | −0.5302 | −0.6913 |
| #30 | −0.3561 | −1.1563 | −0.9135 | −0.4220 | −0.5906 |
| #31 | −1.4893 | −1.6819 | −0.9135 | −0.6384 | −0.6242 |
| #32 | −1.2465 | −2.0322 | −0.9666 | −0.6023 | −0.6074 |
| #33 | −1.2735 | −1.6819 | −0.9135 | −0.4941 | −0.6074 |
| #34 | −0.1943 | −0.9810 | −0.9666 | −0.6745 | −0.5906 |
| #35 | 0.3184 | −0.1927 | −0.6479 | −0.6745 | −0.5906 |
| #36 | −1.6255 | 0.6833 | −0.6479 | −0.6023 | −0.6745 |
| #37 | 0.0755 | −0.9810 | −0.5418 | −0.7106 | −0.6745 |
| #38 | −0.0054 | −0.9810 | −0.5948 | −0.6023 | −0.5906 |
| #39 | −1.2195 | −1.7694 | −0.9135 | −0.6023 | −0.6745 |
| #40 | −0.7608 | −1.0687 | −0.9135 | −0.6384 | −0.5906 |

TABLE 14

| 6 | 7 | 8 | 9 | 10 | 11 |
|---|---|---|---|---|---|
| 0.5927 | 0.8017 | 6.0563 | 0.7657 | 1.0958 | 0.4046 |
| 0.7563 | −0.7018 | −0.8896 | −1.1301 | −0.8850 | −0.6745 |
| 0.8615 | 0.4745 | 0.4592 | 0.7657 | 0.6745 | 1.0791 |
| 0.6862 | 0.9017 | 1.1767 | 0.5833 | 1.0958 | −0.6745 |
| 0.6160 | 0.8654 | 2.4685 | 0.5833 | 1.0958 | 1.2478 |
| 0.9083 | 0.6745 | 0.6027 | 0.5833 | 1.0958 | 0.9104 |
| 0.7680 | 0.9563 | 0.6027 | 0.7657 | 0.6745 | 0.9104 |
| 0.8498 | 1.0290 | 0.6027 | 0.7657 | 0.2528 | 1.0791 |
| 0.8966 | 0.7199 | 0.4592 | 0.5833 | 1.3066 | 0.7420 |
| 0.7212 | 0.9108 | 1.6074 | 0.5833 | 0.4637 | −0.6745 |
| 0.6862 | 0.9381 | 2.3249 | 0.5833 | 1.3066 | 1.0791 |
| 0.7914 | 0.9745 | 0.8898 | 0.2188 | 1.5175 | 1.0791 |
| 0.5810 | 0.8108 | 0.0346 | 0.9481 | 1.0958 | 0.9104 |
| 1.3712 | 0.3800 | 0.9760 | 1.6046 | 1.8548 | −0.6745 |
| 1.3595 | 1.3526 | 1.4064 | −1.1301 | −0.8850 | −0.6745 |
| 1.3712 | 0.9526 | 0.8324 | 1.7867 | 1.6440 | 1.8551 |
| 1.1842 | 1.3890 | 1.4064 | 1.4222 | 2.2765 | 1.1803 |
| 1.1491 | 1.3435 | 1.6935 | 0.8751 | 2.4870 | −0.6745 |
| 1.4881 | −0.0200 | 1.2631 | 0.8751 | 2.2765 | 1.1803 |
| 1.1842 | 1.3344 | 0.9760 | 1.2398 | 1.6440 | 1.8551 |
| −0.6160 | −0.6472 | −0.7463 | −0.5833 | −0.6745 | 0.0000 |
| −0.6277 | −0.5654 | −0.8896 | −1.1301 | −0.4637 | −0.6745 |
| −0.6745 | −0.4745 | −0.8896 | −1.1301 | −0.8850 | −0.6745 |
| −0.6160 | −0.4927 | −0.6027 | −0.5833 | −0.6745 | −0.5061 |
| −0.6160 | −0.5200 | −0.6027 | −0.9481 | −0.8850 | −0.6745 |
| −0.6745 | −0.6745 | −0.7463 | −0.9481 | −0.8850 | −0.3374 |
| −0.6160 | −0.7018 | −0.4592 | −0.5833 | −0.4637 | 0.0000 |
| −0.6277 | −0.5745 | −0.7463 | −0.9481 | −0.2528 | 0.0000 |
| −0.6277 | −0.5745 | −0.6027 | −0.9481 | −0.4637 | −0.1687 |
| −0.6160 | −0.5472 | −0.6027 | −1.1301 | −0.6745 | −0.1687 |
| −0.6160 | −0.6745 | −0.8896 | −1.1301 | −0.8850 | −0.3374 |
| −0.6277 | −0.6745 | −0.4592 | −1.1301 | −0.6745 | −0.5061 |
| −0.6043 | −0.6654 | −0.7463 | −0.9481 | −0.4637 | −0.5061 |
| −0.6511 | −0.4836 | −0.8896 | −0.7657 | −0.8850 | −0.1687 |
| −0.6160 | −0.4836 | 0.2584 | −0.7657 | −0.8850 | 0.0000 |
| −0.6160 | −0.4836 | −0.6027 | −0.7657 | 0.3793 | −0.5061 |
| −0.6862 | −0.4745 | −0.3156 | −0.2186 | −0.4637 | −0.5061 |
| −0.6160 | −0.5018 | −0.4592 | −0.7657 | −0.8850 | −0.6745 |
| −0.6277 | −0.6472 | −0.8896 | −1.1301 | −0.2528 | −0.3374 |
| −0.5927 | −0.6018 | −0.4592 | −1.1301 | −0.8850 | −0.3374 |

The second calculation unit 140 may calculate standardized values for process condition 2 by using Table 3, Table 4, the median value and the median absolute deviation (MADs). The calculated results may correspond to those shown in Table 15 and Table 16.

TABLE 15

| sample # | 1 | 2 | 3 | 4 | 5 |
|---|---|---|---|---|---|
| #1 | 0.1467 | −0.8494 | −0.6847 | −1.8694 | 0.0992 |
| #2 | 0.8901 | −0.3305 | 0.0092 | 1.9388 | −0.3436 |
| #3 | 0.8944 | −0.0040 | 0.0042 | −3.4746 | −0.5333 |
| #4 | −0.4506 | 0.5031 | 0.7245 | 0.2163 | 0.5090 |
| #5 | 0.6041 | −0.5128 | −0.0042 | −3.6911 | −0.8157 |
| #6 | 0.2939 | −0.8437 | −0.6728 | −0.2720 | −1.2070 |
| #7 | −0.2939 | 0.0045 | 0.6839 | 0.8831 | −0.2412 |
| #8 | −1.0376 | −1.5164 | −1.3982 | −2.3633 | 0.0940 |
| #9 | −1.0500 | −1.5263 | −1.3611 | −0.2123 | 0.3210 |
| #10 | 0.8871 | 2.0230 | 2.7596 | 0.0242 | −1.2684 |
| #11 | 1.1935 | 3.7087 | 6.1934 | 7.2369 | 1.5294 |
| #12 | 0.4494 | 2.0275 | 8.2565 | 1.3286 | 1.7112 |
| #13 | 0.7373 | −0.3386 | −0.6927 | 2.5222 | −0.0032 |
| #14 | −1.3473 | −1.3481 | −1.3550 | 0.5184 | −0.0296 |
| #15 | −0.4470 | −0.0062 | 0.7192 | −3.2544 | 0.4941 |
| #16 | −0.5936 | 2.2007 | 2.0402 | 2.3271 | 0.0339 |
| #17 | 0.1443 | 1.6949 | 1.4002 | 4.0310 | −0.3785 |
| #18 | 0.5890 | 1.3503 | 1.3985 | 2.5765 | 0.2434 |
| #19 | 0.1543 | 0.5119 | 8.9421 | 0.0452 | −1.2190 |
| #20 | −0.0071 | 2.6990 | 4.1328 | −1.3557 | −0.1578 |
| #21 | −0.2957 | −0.0070 | −0.0288 | 0.8983 | 1.7189 |
| #22 | −1.3434 | 0.3321 | 0.6608 | −0.5728 | 2.3401 |
| #23 | −0.2957 | −0.8362 | −0.6517 | 0.7762 | −0.0940 |
| #24 | 0.7488 | 2.3602 | 3.4273 | 3.4761 | 1.2356 |
| #25 | 0.7449 | −0.3442 | −0.0293 | 0.0473 | −0.1772 |
| #26 | 0.5913 | 1.0110 | 0.7193 | −1.3099 | 2.3043 |
| #27 | 0.7495 | 0.0040 | −0.0137 | −0.0242 | −1.5899 |
| #28 | −0.4436 | 1.0182 | 0.6762 | 0.4361 | 0.1730 |
| #29 | −0.7435 | −1.1747 | −1.3577 | −0.6128 | −0.1314 |
| #30 | −0.1523 | 1.0084 | 0.7141 | 1.6910 | 1.7161 |
| #31 | −0.3037 | 1.3426 | 1.4003 | 20.7292 | 0.1836 |
| #32 | 0.2971 | −0.8490 | −0.6988 | 5.3158 | 0.7142 |
| #33 | 0.7482 | −0.6780 | −0.7064 | 0.8183 | 0.0517 |
| #34 | 0.2981 | −0.8399 | −0.7082 | 3.9788 | −0.2168 |
| #35 | −0.5987 | −1.3569 | −1.3743 | −1.3597 | 0.1076 |
| #36 | −0.4485 | 0.5064 | 0.6788 | 3.1899 | 0.0107 |
| #37 | 0.8897 | 2.5393 | 2.7397 | 2.1313 | −0.2881 |
| #38 | 0.3003 | −0.6805 | −0.6666 | 3.1631 | 0.3398 |
| #39 | 0.1456 | 0.3341 | 0.7246 | 0.1834 | −0.2629 |
| #40 | 1.1951 | 3.8897 | 0.0367 | 1.3045 | 0.3233 |

TABLE 16

| 6 | 7 | 8 | 9 | 10 | 11 |
|---|---|---|---|---|---|
| 1.4168 | −1.3882 | −2.4660 | −1.4908 | 0.6477 | 0.8254 |
| 1.0117 | −11.3332 | −13.2991 | −19.5058 | −9.3946 | −11.0036 |
| 0.7309 | 0.9329 | −0.1445 | 0.1756 | −0.6929 | 0.9885 |
| −0.1186 | −2.0938 | −0.6740 | −0.0381 | 0.7439 | −11.0036 |
| 0.1340 | 0.4489 | 1.1690 | −0.6779 | −0.5962 | −0.3999 |
| −0.9315 | 1.4700 | 0.6689 | 0.0381 | −0.8963 | −0.6990 |
| −0.0308 | −0.3321 | 0.1445 | 0.1686 | 0.0737 | 0.2755 |
| −2.1502 | −0.4613 | 0.5359 | −0.6711 | 1.4266 | 0.6560 |
| −0.0273 | 0.3454 | 0.6749 | 0.5120 | 0.6561 | 0.1872 |
| −1.3221 | −1.2682 | −1.3213 | −1.0573 | −0.0737 | −11.0036 |
| 1.8232 | 1.0395 | −1.4303 | −2.3187 | −0.4643 | −0.7689 |
| 0.1563 | −1.1472 | −1.2751 | −4.0699 | 0.5618 | 1.5374 |
| −0.4206 | −0.8668 | −1.2077 | −4.1337 | −0.0618 | −11.0036 |
| −0.0090 | −0.1076 | −0.3133 | −19.5058 | −9.3946 | −11.0036 |
| 2.4140 | −0.2589 | 0.6450 | −1.5270 | −1.0175 | −2.0172 |
| 0.0000 | −0.4786 | −1.2055 | −1.5802 | −0.1345 | 0.5979 |
| −0.4049 | −0.9008 | 0.3499 | 0.8144 | 0.1264 | −0.2393 |
| −0.0633 | 0.1798 | 0.5532 | −0.8205 | 0.1870 | −11.0036 |
| −0.2935 | −0.6320 | 3.1785 | 3.5129 | 0.1801 | 1.0138 |
| −2.4593 | −2.4800 | −2.4021 | −1.2634 | −0.1880 | 0.3759 |
| 2.5409 | 0.7265 | −1.6413 | −2.5438 | 0.3840 | 0.5521 |
| 2.0988 | 0.0809 | 0.7155 | −0.9649 | −0.2743 | −11.0036 |
| 1.0835 | −0.0809 | 0.1947 | 1.0000 | −9.3946 | −11.0036 |
| −0.1720 | −2.4266 | −2.2087 | −1.7685 | −1.0212 | −0.1861 |
| 0.0273 | 0.6225 | 0.8045 | 0.0723 | 0.4644 | 0.1861 |
| 1.2414 | −0.8137 | −1.2859 | −4.1420 | −1.0159 | 0.6930 |
| −0.1734 | −1.2493 | −0.5817 | 1.7833 | 0.9130 | 2.2279 |
| 0.6181 | 0.0881 | −0.4466 | 0.4509 | 0.4936 | −0.3063 |
| 1.2306 | −1.8094 | 0.2666 | 0.0156 | −0.7842 | −0.2553 |
| −1.4665 | −1.8544 | −2.2455 | −3.9795 | −0.2335 | −1.1846 |
| 1.4315 | 1.9210 | −2.4694 | −0.9049 | −0.3304 | −1.0064 |
| −1.2764 | −2.5093 | −1.8908 | −2.5272 | 0.4300 | 1.0233 |
| −1.0210 | −0.5163 | −2.8378 | −3.0639 | 0.6021 | 1.3965 |
| −2.5733 | −2.3048 | −2.9425 | −1.3675 | −0.5320 | −0.8136 |
| 0.2876 | 0.3058 | 0.2889 | 0.5015 | 1.5953 | −0.3913 |
| 0.9519 | −1.9885 | −0.9506 | −3.5207 | −0.4053 | −0.1916 |
| −1.0842 | −0.5777 | −2.6325 | 2.7340 | 1.7034 | −0.0648 |
| −1.7367 | −1.7827 | −0.4922 | −2.2320 | −0.5389 | −0.8614 |
| −0.1691 | −0.7300 | −1.1730 | −2.4893 | −0.2915 | −0.6390 |
| 0.1870 | −0.0870 | −3.0287 | −3.3449 | −0.0194 | −0.1643 |

The second calculation unit 140 may calculate standardized values by using the process condition values, the median value, and the standard deviation.

For example, the second calculation unit 140 may calculate a standardized value by using Equation 3.

Standardized value=(Xᵢ−Mean value/Standard Deviation Equation 3

here, Xᵢ is a process condition value.

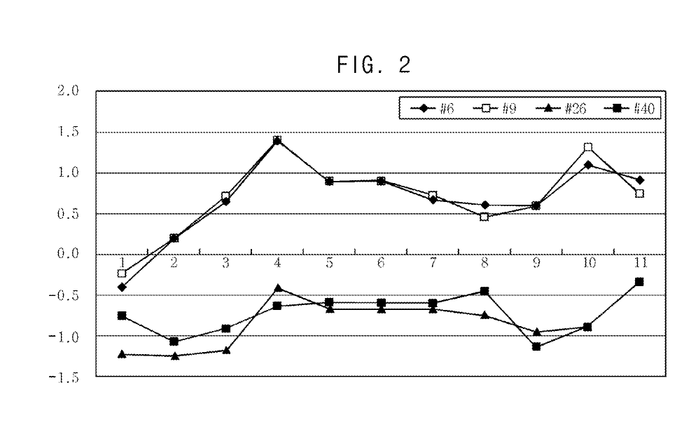

FIG. 2 is a graph depicting standardized values versus sampling points for some samples.

Referring to FIG. 2, the controller 160 may graph the standardized values for sampling points for samples of #6, #9, #26, and #40 among the samples, and display the graph in the display unit 170. A horizontal axis corresponds to sampling points, and a vertical axis corresponds to standardized values. For example, when the controller 160 displays a graph of standardized values versus sampling points for samples, which a user selects or presets, in the display unit 170, the user may easily determine similarity between the samples. For example, the user may easily determine that the samples of #6 and #9 have a similar characteristic, and the samples of #26 and #40 have a similar characteristic.

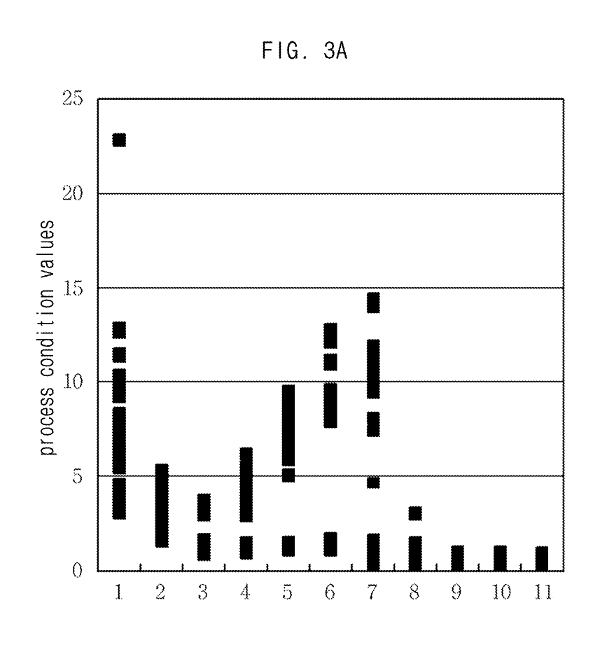

FIGS. 3A and 3B are graphs depicting measured process condition values and standardized values for sampling points.

FIG. 3A is a graph depicting process condition values of Table 1 and Table 2 versus sampling points. A horizontal axis corresponds to sampling points, and a vertical axis corresponds to process condition values.

FIG. 3B is a graph depicting standardized values of Table 13 and Table 14 versus sampling points. A horizontal axis corresponds to sampling points, and a vertical axis corresponds to standardized values.

Referring to FIG. 3A based on first sampling point, there is a difference of about 20 between maximum value and minimum value of the process condition values. Moreover, the process condition values do not gather at a specific location but scatter everywhere. Accordingly, a variance value of the process condition values grows larger, and a difference between the variance values also grows larger.

On the other hand, referring to FIG. 3B based on first sampling point, there is a difference of about 10, which is smaller than the difference between the process condition values of FIG. 3A, between maximum value and minimum value of the standardized values. Moreover, the standardized values uniformly gather at a specific location (‘a magnitude of −2 to 3’). Accordingly, a variance value of the standardized values grows smaller, and a difference between the variance values also grows smaller. The representative value calculating apparatus calculates representative values of the values for the process condition by using the standardized values whose magnitude differences have been reduced, thus improving correctness of the representative value.

The third calculation unit 150 may calculate a representative value of the process condition values for each sample based on the calculated standardized values. The third calculation unit 150 may calculate the representative value of the process condition values based on any one of a mean value, a median value, a mode, a minimum value, a maximum value, and a standard deviation of the calculated standardized values.

If a case in which the third calculation unit 150 calculates the representative value for the process condition values based on the mean value of the calculated standardized values is illustrated, the third calculation unit 150 may calculate a mean value of the calculated standardized values for each sample based on Table 13 and Table 14. Accordingly, the third calculation unit 150 may calculate the representative value of the process condition values for process condition 1. Moreover, the third calculation unit 150 may calculate a mean value of the calculated standardized values for each sample based on Table 15 and Table 16. Accordingly, the third calculation unit 150 may calculate the representative value of the process condition values for process condition 2. For example, the calculated results may correspond to those shown in Table 17.

The controller 160 may allow the calculated representative values to be displayed for each sample.

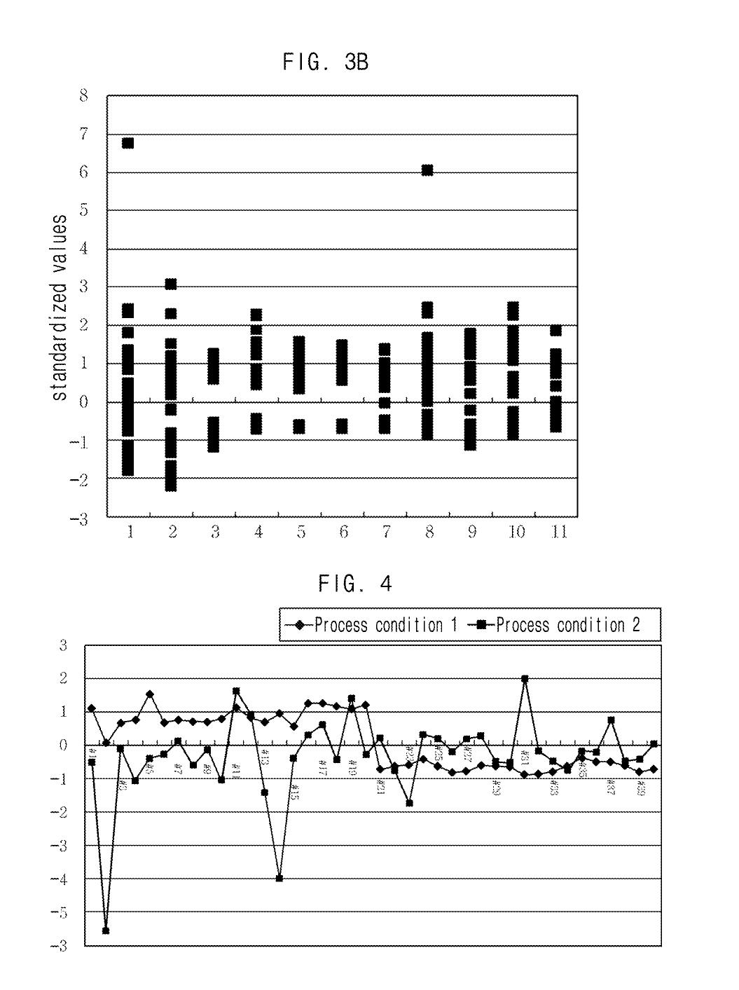

FIG. 4 is a graph depicting calculated representative values versus sampling points. A horizontal axis corresponds to sampling points, and a vertical axis corresponds to representative values.

Referring to FIG. 4, the user can see that among representative values for process condition 1, representative values corresponding to samples of #1 to #20 are positive, and representative values corresponding to samples of #21 to #40 are negative. When determining based on that, the user can see that a state of process condition 1 has been considerably varied in the samples of #20 and #21. For example, it can be seen that when the process condition 1 corresponds to a temperature, the temperature in the samples of #1 to #20 is 110 degrees Celsius, and the temperature in the samples of #21 to #40 is 90 degrees Celsius. At this time, a portion at which the representative value is null corresponds to a temperature of 100 degrees Celsius.

Moreover, the user can see that there is no special pattern of the representative values for process condition 2 in the sample of #1 to #40. When determining based on that, the user can see that a state of process condition 2 has not been varied in a special pattern in the samples of #1 to #40.

In this way, the user can easily determine a degree of a change of the process condition based on the representative values shown for each sampling point.

TABLE 17

| sample # | process condition 1 | process condition 2 |
|---|---|---|
| #1 | 1.0923 | −0.5102 |
| #2 | 0.0574 | −5.5782 |
| #3 | 0.6592 | −0.1021 |
| #4 | 0.7466 | −1.0620 |
| #5 | 1.5316 | −0.3947 |
| #6 | 0.6823 | −0.2774 |
| #7 | 0.7481 | 0.1214 |
| #8 | 0.7097 | −0.6260 |
| #9 | 0.6957 | −0.1346 |
| #10 | 0.7868 | −1.0564 |
| #11 | 1.1143 | 1.6130 |
| #12 | 0.8394 | 0.8670 |
| #13 | 0.6872 | −1.4063 |
| #14 | 0.9402 | −3.9905 |
| #15 | 0.5684 | −0.3869 |
| #16 | 1.2473 | 0.2916 |
| #17 | 1.2543 | 0.6034 |
| #18 | 1.1699 | −0.4372 |
| #19 | 1.0718 | 1.3995 |
| #20 | 1.2010 | −0.2823 |
| #21 | −0.7453 | 0.2094 |
| #22 | −0.6427 | −0.7210 |
| #23 | −0.5950 | −1.7547 |
| #24 | −0.4354 | 0.3150 |
| #25 | −0.6474 | 0.2199 |
| #26 | −0.8186 | −0.1825 |
| #27 | −0.7889 | 0.1860 |
| #28 | −0.6175 | 0.2507 |
| #29 | −0.6325 | −0.4869 |
| #30 | −0.6525 | −0.5442 |
| #31 | −0.8982 | 1.9994 |
| #32 | −0.8661 | −0.1792 |
| #33 | −0.8095 | −0.4733 |
| #34 | −0.6592 | −0.7293 |
| #35 | −0.3890 | −0.1813 |
| #36 | −0.4965 | −0.1970 |
| #37 | −0.4997 | 0.7355 |
| #38 | −0.6069 | −0.4716 |
| #39 | −0.8240 | −0.3970 |
| #40 | −0.7253 | 0.0266 |

In this way, the representative values which may be a representative among the standardized values are calculated so that the number of values which should be analyzed, and the number of values which should be stored are reduced, whereby an effect of data reduction can be achieved.

The third calculation unit 150 may accumulate and add up the calculated standardized values for each sample.

The controller 160 may allow the accumulated and added up values to be displayed for each sampling point.

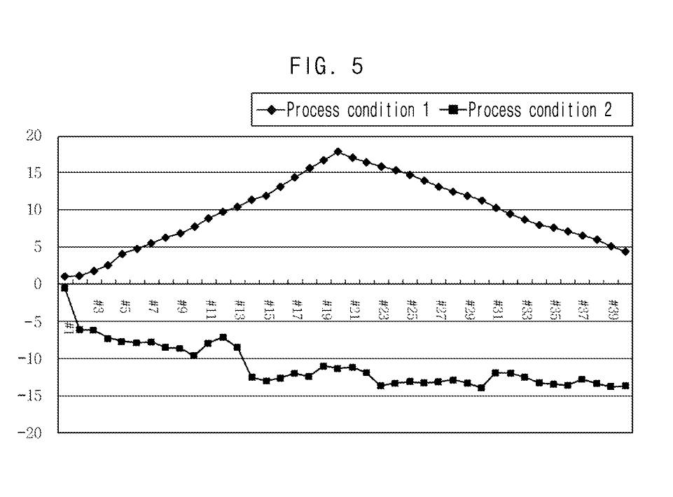

FIG. 5 is a graph depicting accumulated sum values versus sampling points. A vertical axis corresponds to sampling points, and a vertical axis corresponds to accumulated and added up values of representative values.

Referring to FIG. 5, it can be seen that the accumulated and added up values for process condition 1 are varied on the basis of the sample of #20. Accordingly, the user can easily apprehend that process condition 1 is varied before and after the sample of #20.

On the other hand, it can be seen that there is no section in which the accumulated and added up values are largely varied.

In this way, the user can easily determine a degree of a variation of the process condition based on the accumulated and added up values shown according to each sampling point.

The controller 160 may display the standardized values for each sampling point, the calculated representative values for each sample, and the accumulated sum of the calculated representative values for each sample in the display unit 170. Accordingly, the user can see the degree of the variation of various values through the display unit 170, and can easily grasp a state of the apparatus based on the degree of the variation.

In this way, the user can easily determine the degree of the variation of the process condition based on the representative values shown according to each sampling point.

The display unit 170 may display various data generated in the representative value calculating apparatus 100.

The display unit 170 may include at least one of a liquid crystal display (LCD), a thin film transistor-liquid crystal display (TFT-LCD), an organic light emitting diode (OLED), a flexible display, and a three dimensional (3D) display.

Through a standardization process, the representative value calculating apparatus may change the values for the process condition, between which there are large magnitude differences, to the standardized values between which there are small magnitude differences, thus reducing the magnitude differences between the standardized values. The representative value calculating apparatus calculates the representative values of the values for the process condition by using the standardized values with the reduced magnitude differences, whereby correctness of the representative values is enhanced.

Moreover, since the representative values calculating apparatus reduces the magnitude differences between the standardized values so that the correctness of the representative values is enhanced, it is not necessary to intentionally remove, among the values for the measured process conditions, the values corresponding to the portion of deteriorating the correctness of the representative values (‘the portion of generating a transient phenomenon’).

Furthermore, the representative values calculating apparatus reduces the magnitude differences between the standardized values through a standardization process so that several variables with considerably different scales may be displayed all together on one chart, whereby the values corresponding to the variables can be easily compared.

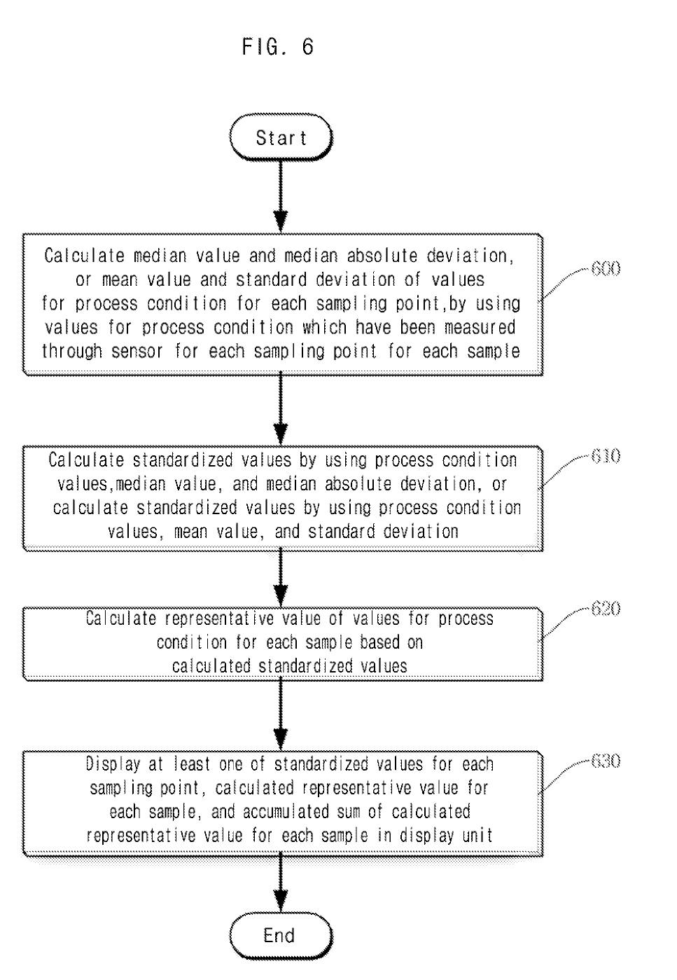

FIG. 6 is a flowchart showing a method, through which a representative value calculating apparatus calculates representative values, according to an embodiment of the present invention.

Referring to FIG. 6, the representative value calculating apparatus may calculate a median value and a median absolute deviation (MAD), or a mean value and a standard deviation of the process condition values for each sampling point, by using the process condition values which have been measured for sampling points for each sample through a sensor (610).

The representative value calculating apparatus may calculate a median absolute deviation (MAD) value by using Equation 1.

MAD=a*Median(|Xᵢ−Median(Xⱼ)|) Equation 1

here, a is a correction factor making the MAD identical with a standard deviation for a normal distribution, Xᵢ is a process condition value, Xⱼ is a median value, and Median(X) is a function calculating a median value among X variables.

The representative value calculating apparatus calculates a standardized value by using process condition values, a median value, and a median absolute deviation (MAD), or calculates a standardized value by using process condition values, a mean value, and a standard deviation.

The representative value calculating apparatus may calculate a standardized value by using Equation 2.

Standardized value=(Xᵢ−Xⱼ)/Median Absolute Deviation(MAD) Equation 2

here, Xᵢ is a process condition value, and Xⱼ is a median value.

Moreover, the representative value calculating apparatus may calculate a standardized value by using Equation 3.

Standardized value=(Xᵢ−Mean value/Standard Deviation Equation 3

here, Xᵢ is a process condition value.

The representative value calculating apparatus calculates a representative value of the process condition values for each sample based on the calculated standardized values (620). For example, the representative value calculating apparatus may calculate the representative value of the process condition values based on any one of a mean value, a median value, a mode, a minimum value, a maximum value, and a standard deviation of the calculated standardized values.

The representative value calculating apparatus displays at least one of the standardized values for each sampling point, the calculated representative values for each sample, and the accumulated sum of the calculated representative values for each sample (630).

In the representative value calculating method, through a standardization process, the values for the process condition between which there are large magnitude differences is changed to the standardized values between which there are small magnitude differences so that the magnitude differences between the standardized values may be reduced. In the representative value calculating method, the representative values of the values for the process conditions are calculated by using the standardized values with the reduced magnitude differences, whereby correctness of the representative values is enhanced.

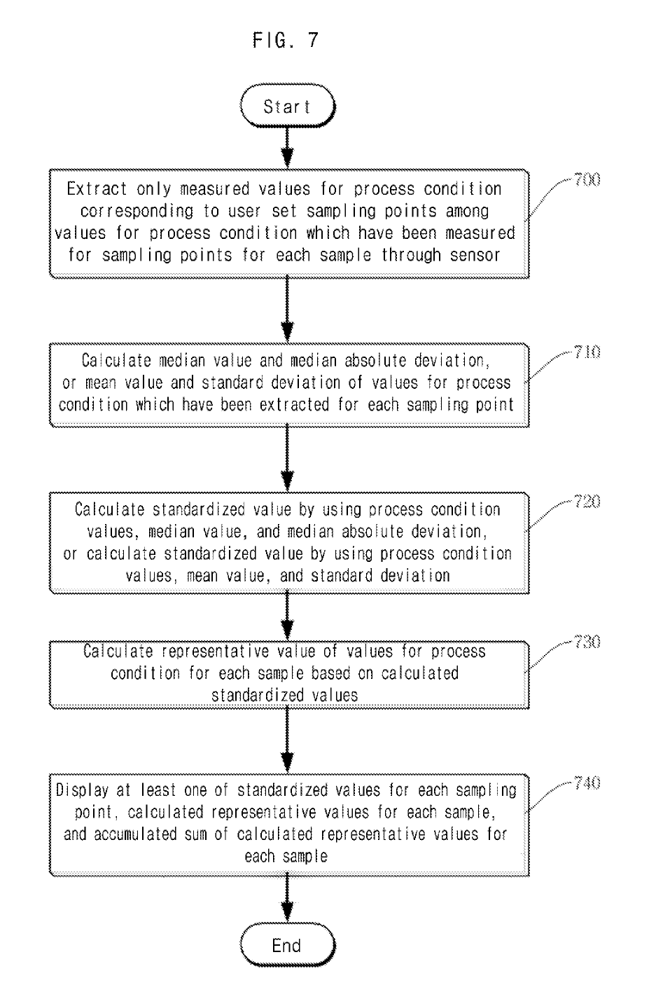

FIG. 7 is a flowchart showing a method, through which a representative value calculating apparatus calculates representative values, according to another embodiment of the present invention.

Referring to FIG. 7, the representative value calculating apparatus extracts only process condition values corresponding to a user set sampling points among the process condition values which have been measured for sampling points for each sample through a sensor (700).

The representative value calculating apparatus calculates a median value and a median absolute deviation (MAD), or a mean value and a standard deviation of values for process conditions which have been extracted for each sampling point (710).

The representative value calculating apparatus calculates a standardized value by using process condition values, a median value, and a median absolute deviation (MAD), or calculates a standardized value by using process condition values, a mean value, and a standard deviation (720).

The representative value calculating apparatus calculates a representative value of the process condition values for each sample based on the calculated standardized values (730).

The representative value calculating apparatus displays at least one of the standardized values for each sampling point, the calculated representative values for each sample, and the accumulated sum of the calculated representative values for each sample (740).

The embodiments which have been described may be configured through selected combinations of all or some of the embodiments such that various modifications thereof may be achieved.

Moreover, the above-described embodiments should be understood illustrative, and not restrictive in all aspects. Furthermore, it will be understood that various modifications and variations can be made by those skilled in the art to which the present invention pertains without departing from the spirit and scope of the present invention.

In addition, according to an embodiment of the present invention, the above-described method may be realized as a processor readable code in a program recorded medium. As an example of the processor readable medium, a ROM, a RAM, a magnetic tape, a floppy disk, and an optical data storage device are illustrated, and a medium realized in a form of a carrier wave (for example, transmission through the internet) is also included in the processor readable medium

What is claimed is:

1. A representative value calculating apparatus comprising:
a first calculation unit which calculates a median value and a median absolute deviation (MAD), or a mean value and a standard deviation of process condition values for each sampling point, by using the process condition values which have been measured through a sensor for the each sampling point for each sample;
a second calculation unit which calculates standardized values by using the process condition values, the median value, and the median absolute deviation (MAD), or calculates standardized values by using the process condition values, the mean value, and the standard deviation; and
a third calculation unit which calculates a representative value of the process condition values for the each sample based on the calculated standardized values.

2. The representative value calculating apparatus of claim 1, further comprising:
an extraction unit which extracts only the process condition values corresponding to sampling points which have been set by a user among the measured process condition values.

3. The representative value calculating apparatus of claim 1, wherein the first calculation unit calculates the median absolute deviation (MAD) by using Equation 1:
MAD=a*Median(|Xᵢ−Median(Xⱼ)|) Equation 1
here, a is a correction factor making the MAD identical with a standard deviation for a normal distribution, Xᵢ is a process condition value, Xⱼ is a median value, and Median(X) is a function calculating a median value among X variables.

4. The representative value calculating apparatus of claim 1, wherein the second calculation unit calculates the standardized value by using Equation 2:
Standardized value=(Xᵢ−Xⱼ)/Median Absolute Deviation(MAD) Equation 2
here, Xᵢ is a process condition value, and Xⱼ is a median value.

5. The representative value calculating apparatus of claim 1, wherein the second calculation unit calculates the standardized value by using Equation 3:
Standardized value=(Xᵢ−Mean value/Standard Deviation Equation 3
here, Xᵢ, is a process condition value.

6. The representative value calculating apparatus of claim 1, wherein the third calculation unit calculates a representative value of the process condition values based on any one of a mean value, a median value, a mode, a minimum value, a maximum value, and a standard deviation of the calculated standardized values.

7. The representative value calculating apparatus of claim 1, further comprising:
a controller which displays at least one of the standardized values for the each sampling point, the calculated representative value for the each sample, and an accumulated sum of the calculated representative value for the each sample in a display unit.

8. The representative value calculating apparatus of claim 1, wherein the process condition comprises at least one of a temperature, a pressure, a time, and a location of a product.

9. A representative value calculating method comprising:
calculating a median value and a median absolute deviation (MAD), or a mean value and a standard deviation of process condition values for each sampling point, by using the process condition values which have been measured through a sensor for the each sampling point for each sample;
calculating standardized values by using the process condition values, the median value, and the median absolute deviation (MAD), or calculating standardized values by using the process condition values, the mean value, and the standard deviation; and
calculating a representative value of the process condition values for the each sample based on the calculated standardized values.

10. The representative value calculating method of claim 9, further comprising:
extracting only the process condition values corresponding to sampling points which have been set by a user among the measured process condition values.

11. The representative value calculating method of claim 9, wherein calculating the median value and the median absolute deviation (MAD), or the mean value and the standard deviation comprises calculating the median absolute deviation (MAD) by using Equation 1:
MAD=a*Median(|Xᵢ−Median(Xⱼ)|) Equation 1
here, a is a correction factor making the MAD identical with a standard deviation for a normal distribution, Xᵢ is a process condition value, Xⱼ is a median value, and Median(X) is a function calculating a median value among X variables.

12. The representative value calculating method of claim 9, wherein calculating the standardized values comprises calculating the standardized value by using Equation 2:
Standardized value=(Xᵢ−Xⱼ)/Median Absolute Deviation(MAD) Equation 2
here, Xᵢ is a process condition value, and Xⱼ is a median value.

13. The representative value calculating method of claim 9, wherein calculating the standardized value comprises calculating the standardized value by using Equation 3:
Standardized value=(Xᵢ−Mean value/Standard Deviation Equation 3
here, Xᵢ is a process condition value.

14. The representative value calculating method of claim 9, wherein calculating the representative value comprises calculating the representative value of the process condition values based on any one of a mean value, a median value, a mode, a minimum value, a maximum value, and a standard deviation of the calculated standardized values.

15. The representative value calculating method of claim 9, further comprising:
displaying at least one of the standardized values for the each sampling point, the calculated representative value for the each sample, and an accumulated sum of the calculated representative value for the each sample in a display unit.
